(19) United States
(12) Patent Application Publication
(10) Pub. No.: US 2025/0070441 A1
(43) Pub. Date: Feb. 27, 2025

(54) RESONATOR AND FILTER

(71) Applicant: Suzhou Luxshare Technology Co., Ltd., Suzhou City (CN)

(72) Inventors: Zhenguo Song, Suzhou City (CN); Shance Lyu, Suzhou City (CN); Shaodong Li, Suzhou City (CN)

(73) Assignee: Suzhou Luxshare Technology Co., Ltd., Suzhou City (CN)

(21) Appl. No.: 18/769,013

(22) Filed: Jul. 10, 2024

(30) Foreign Application Priority Data
Aug. 24, 2023 (CN) 202322289018.5

(51) Int. Cl. H01P 1/205

(52) U.S. Cl. CPC H01P 1/2053

(57) ABSTRACT

This embodiment discloses a resonator and a filter. The resonator comprises a housing, a cover plate, a metal resonant rod, a dielectric member and a fixing member. The housing includes a resonant cavity with an opening. The cover plate covers the opening and connects to the housing. The metal resonant rod, dielectric member, and fixing member are set in the resonant cavity. The dielectric member is set on the metal resonant rod. The fixing member is detachably connected to the outside of the dielectric member and the metal resonant rod. The dielectric member is fixedly connected to the fixing member and the metal resonant rod. The fixing member is detachably connected to the metal resonant rod and the dielectric member through a sleeve arrangement, and the dielectric member is limited and fixed on the metal resonant rod, improving the tuning performance of the resonator while effectively reducing its cost.

### CLAIM OF PRIORITY AND CROSS-REFERENCE TO RELATED APPLICATION(S)

This application claims the benefit of Chinese Patent Application No. 202322289018.5, filed on Aug. 24, 2023, which is incorporated herein by reference in its entirety.

### BACKGROUND OF THE DISCLOSURE

### 1. Field of the Disclosure

The present disclosure relates to the field of electronic device technology, and particularly to a resonator and a filter.

### 2. Description of the Related Art

As a frequency selection device, filters are widely used in the field of radio frequency communication. Resonators are one of the important components of filters. The main components of resonators include shells, resonant rods, etc. Among them, the resonant rod combined with metal resonant rods and dielectric resonant rods is the most widely used. In most resonators, the metal resonant rod and dielectric resonant rod are connected together by welding or pressing. Among them, the welding method is prone to causing the connection between the metal resonant rod and the dielectric resonant rod to rupture due to significant differences in deformation, which affects the performance. The pressing method is to use the cover or housing of the resonator to press the dielectric resonant rod and the metal resonant rod together, and it is necessary to add an elastic structure on the shell of the resonator to fix the dielectric resonant rod, which has poor stability.

### BRIEF DESCRIPTION OF THE DISCLOSURE

In view of this, the present disclosure provides a resonator and a filter that may be connected to a metal resonant rod and a dielectric resonant rod using a method different from welding and pressing to improve the tuning performance of the resonator.

In the first aspect, the embodiment of the present disclosure provides a resonator comprising: a housing comprising a resonant cavity with an opening; a cover plate covering the outside of the opening of the resonant cavity and connected to the housing; a metal resonant rod disposed in the resonant cavity; a dielectric member disposed in the resonant cavity, the dielectric member being disposed on the metal resonant rod; and a fixing member disposed in the resonant cavity, detachably connected to the outside of the metal resonant rod and the dielectric member, and the dielectric member is limitedly connected between the fixing member and the metal resonant rod.

Furthermore, the bottom of the fixing member has a connecting cavity with an opening, the top of the fixing member has a through hole communicating with the connecting cavity, and the connecting cavity is provided with an internal thread; the dielectric member and the metal resonant rod are installed in the connecting cavity, the outside of the metal resonant rod is provided with an external thread, the metal resonant rod and the fixing member are connected through the external thread and the internal thread, the top of the fixing member is pressed against the dielectric member.

Furthermore, the metal resonant rod comprises a first resonant part and a second resonant part connected axially, the outer diameter of the first resonant part is larger than that of the second resonant part, a first cavity is arranged inside the first resonant part, a second cavity communicating with the first cavity is arranged inside the second resonant part, the inner diameter of the first cavity is larger than that of the second cavity, and the dielectric member is arranged inside the first cavity.

Furthermore, the external thread is provided on the outside of the first resonant part, the first resonant part and the connecting cavity are connected through the external thread and the internal thread.

Furthermore, the top surface of the dielectric member is located on the same plane as the top surface of the metal resonant rod, the top of the fixing member simultaneously presses against the metal resonant rod and the dielectric member.

Furthermore, the dielectric member comprises a first dielectric body and a second dielectric body connected axially, the outer diameter of the first dielectric body is larger than that of the second dielectric body, the first dielectric body is disposed in the first cavity, and the top surface of the first dielectric body is located on the same plane as the top surface of the first resonant part, the second dielectric body extends from the through hole, and the top of the fixing member is pressed against the first resonant part and the first dielectric body.

Furthermore, the dielectric member is formed with an inner cavity which is in communication with the second cavity.

Furthermore, the diameter of the through hole is smaller than the inner diameter of the connecting cavity and is greater than or equal to the inner diameter of the inner cavity of the dielectric member.

Furthermore, the resonator further comprises a tuning screw and a nut connected to the tuning screw, the tuning screw is threaded connected to the cover plate and extends through the cover plate into the resonant cavity, and the nut is located outside the cover plate.

In the second aspect, the embodiment of the present disclosure provides a filter comprising: a resonator according to the first aspect, the housing of the resonator further comprises a mounting platform protruding from the bottom surface of the resonant cavity, the metal resonant rod is fixed on the mounting platform, the metal resonant rod and the mounting platform are connected by a connecting bolt.

This disclosure embodiment provides a resonator and a filter. The resonator comprises a housing, a cover plate, a metal resonant rod, a dielectric member, and a fixing member. The housing includes a resonant cavity with one side opening. The cover plate and the housing cover the outside of the opening of the resonant cavity and the cover plate is connected to the housing. The metal resonant rod, the dielectric member, and the fixing member are set in the resonant cavity, wherein the dielectric member is set on the metal resonant rod, the fixing member is detachably connected to the outer side of the dielectric member and the metal resonant rod, and the dielectric member is fixedly connected to the fixed part and the metal resonant rod. The fixing member is detachably connected to the metal resonant rod and the dielectric member through a sleeve arrangement, and the dielectric member is limited and fixed on the metal resonant rod, improving the tuning performance of the resonator while effectively reducing cost of the resonator.

### BRIEF DESCRIPTION OF THE DRAWINGS

The above and other objectives, features, and advantages of the disclosure will become clearer through the description of the embodiment of the disclosure with reference to the accompanying drawings, in which:

FIG. 1 is a sectional view of a resonator of the embodiment of the disclosure.

FIG. 2 is a sectional view of a metal resonant rod in the embodiment of the present disclosure.

FIG. 3 is a sectional view of a dielectric member of the embodiment of the present disclosure.

FIG. 4 is a sectional view of a fixing member of the embodiment of the present disclosure.

FIG. 5 is a sectional view of a resonator without a connecting bolt in this disclosure.

FIG. 6 is a sectional view of a metal resonant rod, a dielectric member, and a fixing member of another embodiment of the present disclosure.

FIG. 7 is a sectional view of a metal resonant rod, a dielectric member, and a fixing member of another embodiment of the present disclosure.

FIG. 8 is a sectional view of a metal resonant rod, a dielectric member, and a fixing member in another embodiment of the present disclosure.

### DETAILED DESCRIPTION OF EMBODIMENTS OF THE DISCLOSURE

The following describes this application based on embodiments, but this application is not limited to these embodiments. In the following detailed description of this application, some specific details are elaborately described. For those skilled in the art, the absence of detailed descriptions of these details does not prevent them from fully understanding this application. To avoid confusing the essence of this application, well-known methods, processes, flows, components, and circuits are not detailed.

In addition, those skilled in the art should understand that the figures provided here are for illustrative purposes only, and the figures may not be drawn to scale.

Unless otherwise clearly specified and defined, the terms “installation”, “connection”, “fixation”, and others should be understood broadly. For example, they may be fixed connections, or they may be detachable connections, or integrated; they may be mechanical connections, or electrical connections; they may be direct connections, or indirect connections through an intermediate medium, they may be internal connections between two components or the interaction between two components, unless otherwise clearly defined. For those skilled in the art, the specific meaning of the above terms in this application may be understood based on the specific situation.

Unless explicitly required by the context, the words “include”, “contains”, and similar terms throughout the application document should be interpreted as inclusive rather than exclusive or exhaustive; that is, they have the meaning of “including but not limited to”.

In the description of this application, it is necessary to understand that the terms “first”, “second”, etc. are only used for descriptive purposes and should not be understood as indicating or implying relative importance. Furthermore, in the description of this application, unless otherwise specified, the meaning of “multiple” is two or more.

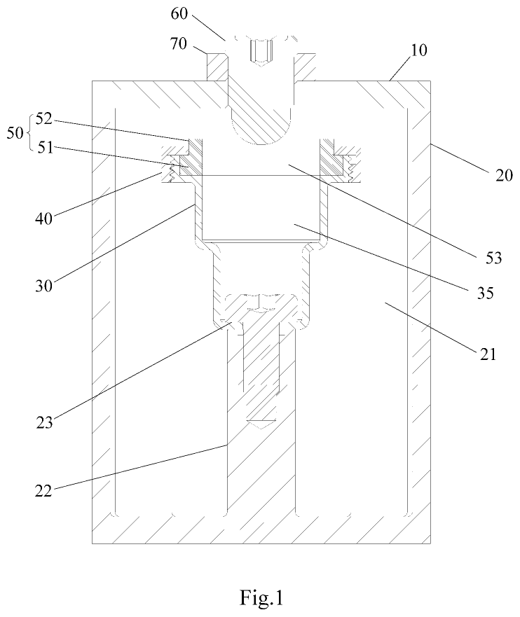

FIG. 1 is a sectional view of a resonator of the embodiment of the disclosure. As shown in FIG. 1, the resonator includes a housing 20, a cover plate 10, a metal resonant rod 30, a dielectric member 50, and a fixing member 40. A resonant cavity 21 with an opening on one side is formed inside the housing 20, and the cover plate 10 is connected to the outside of the opening of the resonant cavity 21 and to the housing 20. The metal resonant rod 30, the dielectric member 50, and the fixing member 40 are arranged inside the resonant cavity 21. Optionally, the cover plate 10 may be connected to the housing 20 by screws or by conductive glue.

To maintain good conductivity between the housing 20 and the cover plate 10, the housing 20 and the cover plate 10 are made of surface-plated metal materials. Specifically, the surfaces of the housing 20 and the cover plate 10 may be treated with silver plating or copper plating. Optionally, the base materials of the housing 20 and the cover plate 10 may be selected from metal materials, such as aluminum alloy materials, or plastic materials.

As shown in FIG. 1, the metal resonant rod 30 is fixed inside the resonant cavity 21 on the side opposite to the cover plate 10. The dielectric member 50 is placed on the metal resonant rod 30, and the fixing member 40 is detachably connected to the outside of the metal resonant rod 30 and the dielectric member 50. The dielectric member 50 is fixed in place between the fixing member 40 and the metal resonant rod 30. The fixing member 40 is detachably connected to the metal resonant rod 30 and the dielectric member 50 in a sleeve-type manner, which facilitates the disassembly of the metal resonant rod 30 and the dielectric member 50 during maintenance. At the same time, the fixing member 40 fixedly connects the dielectric member 50 to the metal resonant rod 30, effectively improving the tuning performance of the resonator and reducing costs.

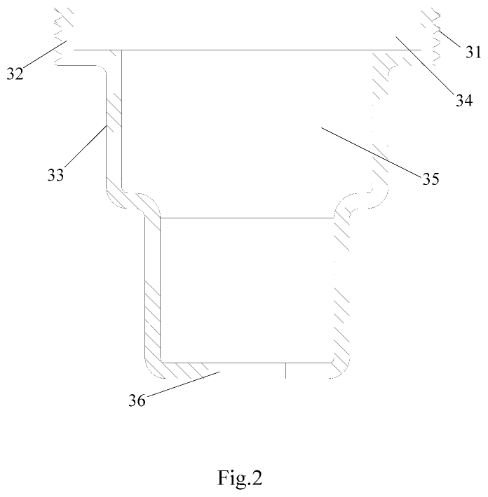

Furthermore, as shown in FIG. 2, the metal resonant rod 30 includes a first resonant part 32 and a second resonant part 33 connected axially. A first cavity 34 is provided inside the first resonant part 32, and a second cavity 35 is provided inside the second resonant part 33. The first cavity 34 is connected to the second cavity 35. The outer diameter of the first resonant part 32 is larger than that of the second resonant part 33, and the inner diameter of the first cavity 34 is larger than that of the second cavity 35. Optionally, the first cavity 34 and the second cavity 35 are coaxially arranged, which may effectively increase the stability of the resonator. The connection between the first resonant part 32 and the second resonant part 33 forms a horizontal plane, so that the dielectric member 50 may be placed smoothly inside the first cavity 34.

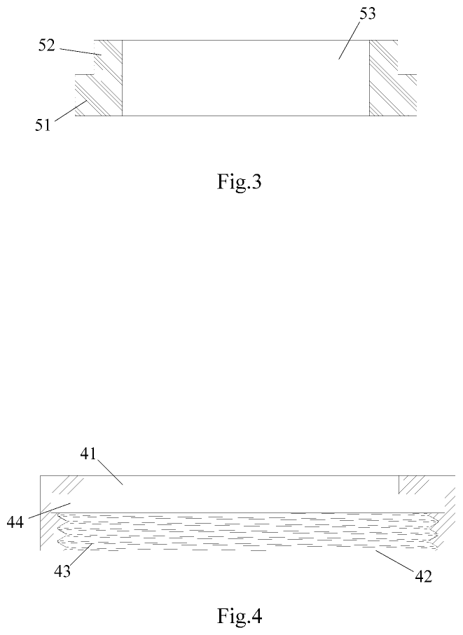

Furthermore, as shown in FIG. 3, the dielectric member 50 includes a first dielectric body 51 and a second dielectric body 52 connected axially, with the outer diameter of the first dielectric body 51 being larger than that of the second dielectric body 52. The first dielectric body 51 is positioned within the first cavity 34 of the metal resonant rod 30, and the top surface of the first dielectric body 51 is on the same plane as the top surface of the first resonant part 32. The second dielectric body 52 is located on the side of the first dielectric body 51 away from the metal resonant rod 30. Specifically, the outer diameter of the first dielectric body 51 is smaller than the inner diameter of the first cavity 34 and larger than the inner diameter of the second cavity 35, allowing the first dielectric body 51 to be positioned within the first cavity 34.

Furthermore, as shown in FIG. 1, an inner cavity 53 is formed inside the dielectric member 50, which is connected to the second cavity 35 of the metal resonant rod 30, and the inner diameter of the inner cavity 53 is the same as that of the second cavity 35, which may improve the tuning performance of the resonator while enhancing stability.

Furthermore, as shown in FIG. 4, the fixing member 40 has a connecting cavity 42 at the bottom with an opening and a through hole 41 at the top, which is connected to the connecting cavity 42. The diameter of the through hole 41 is smaller than the inner diameter of the connecting cavity 42, and the through hole 41 is coaxially arranged with the connecting cavity 42 to ensure the stability of the resonator. At the same time, the diameter of the through hole 41 is larger than the inner diameter of the inner cavity 53 of the dielectric member 50, so that when the fixing member 40 is connected to the metal resonant rod 30 and the dielectric member 50, the fixing member 40 may press the metal resonant rod 30 and the dielectric member 50 into the connecting cavity 42 from the bottom opening.

Specifically, an internal thread 43 is provided inside the connecting cavity 42 of the fixing member 40, an external thread 31 is provided on the outside of the first resonant part 32 of the metal resonant rod 30, and the first resonant part 32 is threaded connected to the connecting cavity 42 via the external thread 31 and the internal thread 43. As shown in FIG. 1, the top of the fixing member 40 is pressed against the top surface of the first resonant part 32 and the top surface of the first dielectric member 51, thereby retaining the first dielectric member 51 within the first cavity 34 of the metal resonant rod 30, while ensuring that the dielectric member 50 is tightly connected to the metal resonant rod 30, enhancing the tuning performance of the resonator.

Furthermore, as shown in FIG. 4, a relief groove 44 is provided between the top of the connecting cavity 42 and the internal thread 43, which enables the inner top of the fixing member 40 to closely fit to the top surface of the metal resonant rod 30 and the top surface of the dielectric member 50, preventing fatigue failure caused by premature loosening.

Furthermore, as shown in FIG. 1, the second dielectric body 52 of the dielectric member 50 extends from the through hole 41 at the top of the fixing member 40 to enhance resonator control and tuning frequency. Optionally, the outer diameter of the second dielectric body 52 is the same as the diameter of the through hole 41 to ensure stable conductive connection between the fixing member 40 and the dielectric member 50. A certain gap is reserved between the second dielectric body 52 and the cover plate 10 to form a single-ended open-circuit structure. Therefore, the cover plate 10 may be a single-layer cover plate to improve product stability. Optionally, a multi-layer cover plate may also be used to abut against the dielectric member 50 to increase the stability of the dielectric member 50 and the metal resonant rod 30 within the resonant cavity 21.

Furthermore, the metal resonant rod 30, dielectric member 50, and fixing member 40 are all made of conductive materials. Optionally, the dielectric member 50 may be sintered from ceramic materials with a high dielectric constant. Applying a high dielectric constant dielectric on top of the metal resonant rod 30 may improve the quality factor of the resonator, thereby improving the insertion loss of the filter.

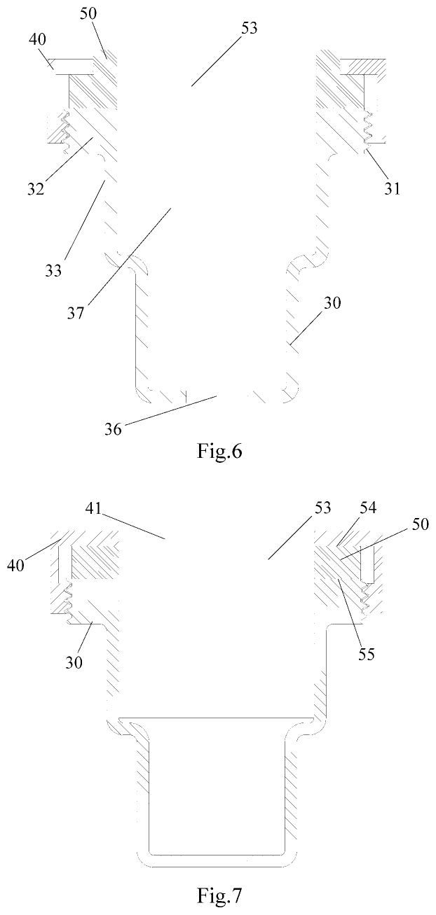

In an optional embodiment, as shown in FIG. 6, a cavity 37 is formed inside the metal resonant rod 30. The cavity 37 is coaxially connected with the inner cavity 53 of the dielectric member 50, and the inner diameter of the cavity 37 is same as that of the inner cavity 53, effectively reducing the coaxial tolerance of the first resonant part 32 and the second resonant part 33, and may effectively enhance the tuning performance and stability of the resonator. Furthermore, the outer diameter of the first resonant part 32 of the metal resonant rod 30 is larger than that of the second resonant part 33, so that the dielectric member 50 may be smoothly placed at the top of the first resonant part 32. The inner top of the fixing member 40 is pressed against the top surface of the first dielectric body 51 to fix the dielectric member 50 at the top of the metal resonant rod 30. The first resonant part 32 of the metal resonant rod 30 is provided with an external thread 31 on the outside, which cooperates with the internal thread 43 of the fixing member 40 for screw connection, thereby achieving the limited fixation of the dielectric member 50 at the top of the metal resonant rod 30. The resonator in this embodiment may effectively reduce the volume of the resonant rod, achieving miniaturization of the resonator. As shown in FIG. 3 and FIG. 4, the specific descriptions of the fixing member 40 and the dielectric member 50 in this embodiment may refer to the corresponding descriptions in the previous embodiments, and are not repeated here.

In another optional embodiment, as shown in FIG. 7, the upper end surface 54 of the dielectric member 50 abuts against the inner top of the fixing member 40, the lower end surface 55 abuts against the top of the metal resonant rod 30, and the dimensions of the upper end surface 54 and the lower end surface 55 are the same. As shown in FIG. 4, the fixing member 40 includes a connecting cavity 42 with an open bottom, a through hole 41 at the top, and an internal thread 43 on the inside. The dielectric member 50 and the metal resonant rod 30 are fixedly connected within the connecting cavity 42 from the open bottom. Inside the dielectric member 50, there is formed an inner cavity 53. The diameter of the through hole 41 at the top of the fixing member 40 is larger than that of the connecting cavity 42 and is equal to or greater than the inner diameter of the inner cavity 53. Optionally, the diameter of the through hole 41 is equal to the inner diameter of the inner cavity 53, so that when the through hole 41, the inner cavity 53, and the cavity 37 of the metal resonant rod 30 are coaxially arranged, it may reduce the coaxial tolerance between the fixing member 40, dielectric member 50, and metal resonant rod 30, while facilitating frequency tuning and increasing the stability of the resonator. Furthermore, the inner top of the fixing member 40 presses against the upper end surface 54 of the dielectric member 50, and the fixing member 40 is threaded connected to the metal resonant rod 30. The resonator in this embodiment may effectively reduce the volume of the resonant rod, achieving miniaturization of the resonator. For a detailed description of the metal resonant rod 30 in this embodiment, reference may be made to the corresponding descriptions in the previous embodiments, which will not be repeated here.

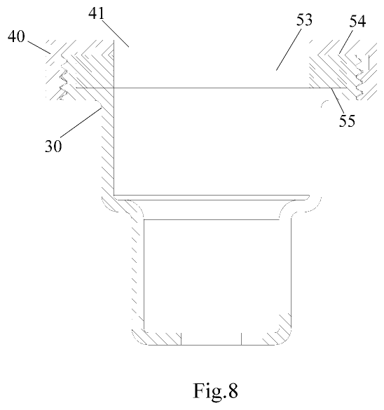

In another optional embodiment, as shown in FIG. 2 and FIG. 8, the metal resonant rod 30 includes a first resonant part 32 and a second resonant part 33 connected axially. The first resonant part 32 has a first cavity 34 inside, the second resonant part 33 has a second cavity 35 inside, the first cavity 34 and the second cavity 35 are coaxially connected. The outer diameter of the first resonant part 32 is larger than that of the second resonant part 33, and the inner diameter of the first cavity 34 is larger than that of the second cavity 35. The connection between the first resonant part 32 and the second resonant part 33 forms a horizontal plane, allowing the dielectric member 50 to be placed smoothly inside the first cavity 34. The upper end surface 54 of the dielectric member 50 is on the same plane as the top surface of the first resonant part 32. When the fixing member 40 is threaded connected to the metal resonant rod 30, the inner top of the fixing member 40 presses against the upper end surface 54 of the dielectric member 50 and the top surface of the first resonant part 32, securing the dielectric member 50 within the first cavity 34 of the metal resonant rod 30. The resonator in this embodiment effectively reduces the volume of the resonant rod, achieving miniaturization of the resonator. For detailed descriptions of the dielectric member 50 and the fixing member 40, refer to the corresponding descriptions in the previous embodiments, which will not be repeated here.

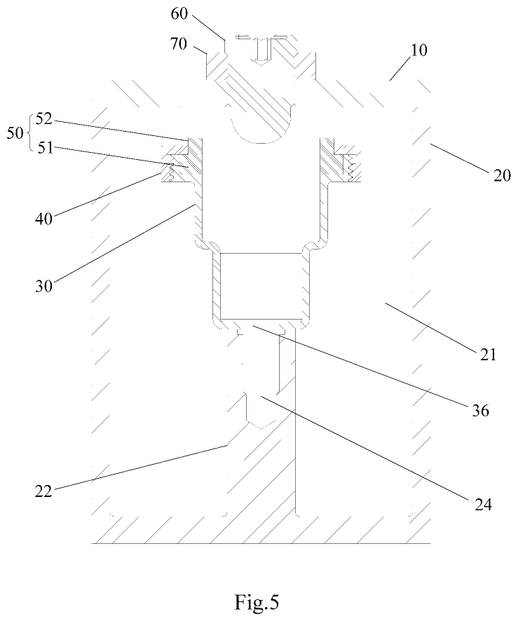

Furthermore, as shown in FIG. 1, a mounting platform 22 protrudes on the side opposite the open end inside the resonant cavity 21, and the height of the mounting platform 22 is determined by the temperature drift index of the filter in this embodiment. The mounting platform 22 is provided with a threaded hole 24, as shown in FIG. 5. A connecting bolt 23 passes through the connecting hole 36 at the bottom of the metal resonant rod 30 and is threaded connected to the threaded hole 24 of the mounting platform 22, allowing the metal resonant rod 30 to be fixedly connected to the housing 20, thereby restricting the movement of the metal resonant rod 30 in the resonant cavity 21 and increasing the stability of the resonator in the axial direction.

Furthermore, when the distance between the metal resonant rod 30, the dielectric member 50, and the cover plate 10 remains constant, adjusting the diameter of the mounting platform 22 may adjust the resonant frequency of the resonant cavity 21 to achieve a better tuning effect.

Optionally, the mounting platform 22 may be integrally connected with the housing 20, or the mounting platform 22 may separate from the housing 20 independently.

Furthermore, as shown in FIG. 1, the resonator also includes a tuning screw 60 and a nut 70. The nut 70 is located on the outside of the cover plate 10 and is connected to the tuning screw 60 to increase the stability of the tuning screw 60 during adjustment. The tuning screw 60 is threaded connected to the cover plate 10 and extends through the cover plate 10 into the inner cavity 53 of the dielectric member 50 or into the second cavity 35 of the metal resonant rod 30 through the inner cavity 53. The resonator adjusts the depth of the tuning screw 60 extending into the resonant cavity 21 to correspondingly adjust the coupling amount, ensuring that the coupling amount meets the required specifications. The tuning screw 60 is made of a surface-plated metal material. Specifically, the tuning screw 60 may be made of silver-plated or copper-plated parts. Furthermore, the tuning screw 60 is electrically connected to the cover plate 10, and the part of the tuning screw 60 extending into the inner cavity 53 forms capacitive coupling with the dielectric member 50 and the metal resonant rod 30, allowing the resonator to change the size of the coupling capacitance by adjusting the depth of the tuning screw 60 within the resonant cavity 21, thereby adjusting the resonant frequency of the resonator.

It can be understood that in this embodiment, the fixing member 40 is threaded connected to the metal resonant rod 30, thereby pressing the dielectric member 50 and the metal resonant rod 30 together. This method may be applied to other suitable resonators.

Furthermore, the embodiment of the disclosure also provides a filter, which includes the aforementioned resonant cavity.

The resonator of this embodiment has a fixing member with an opening at the bottom fitted over the metal resonant rod and the outside of the dielectric member. The internal thread on the inside of the fixing member matches with the external thread on the outside of the metal resonant rod for threaded connection. At the same time, the top of the fixing member is pressed against the top of the metal resonant rod and the dielectric member. This embodiment firmly presses the dielectric member above the metal resonant rod through threaded connection, which may effectively reduce the maximum field strength of the resonator and improve the power specifications of the filter. Compared to a fully dielectric resonator, the combination of the dielectric member, the buffer member, and the metal resonant rod ensures the performance specifications of the resonator while also effectively reducing costs.

The above-mentioned is only a preferred embodiment of this application and is not intended to limit this application. For those skilled in the art, this application may be subject to various modifications and variations. Any modifications, equivalent replacements, and improvements made within the spirit and principle of this application should be included in the scope of protection of this application.

I/We claim:

1. A resonator, comprises:
a housing comprising a resonant cavity with an opening;
a cover plate covering the outside of the opening of the resonant cavity and connected to the housing;
a metal resonant rod disposed in the resonant cavity;
a dielectric member disposed in the resonant cavity, the dielectric member being disposed on the metal resonant rod; and
a fixing member disposed in the resonant cavity, detachably connected to the outside of the metal resonant rod and the dielectric member, and the dielectric member is limitedly connected between the fixing member and the metal resonant rod.

2. The resonator according to claim 1, wherein the bottom of the fixing member has a connecting cavity with an opening, the top of the fixing member has a through hole communicating with the connecting cavity, and the connecting cavity is provided with an internal thread;
the dielectric member and the metal resonant rod are installed in the connecting cavity, the outside of the metal resonant rod is provided with an external thread, the metal resonant rod and the fixing member are connected through the external thread and the internal thread, the top of the fixing member is pressed against the dielectric member.

3. The resonator according to claim 2, wherein the metal resonant rod comprises a first resonant part and a second resonant part connected axially, the outer diameter of the first resonant part is larger than that of the second resonant part, a first cavity is arranged inside the first resonant part, a second cavity communicating with the first cavity is arranged inside the second resonant part, the inner diameter of the first cavity is larger than that of the second cavity, and the dielectric member is arranged inside the first cavity.

4. The resonator according to claim 3, wherein the external thread is provided on the outside of the first resonant part, the first resonant part and the connecting cavity are connected through the external thread and the internal thread.

5. The resonator according to claim 3, wherein the top surface of the dielectric member is located on the same plane as the top surface of the metal resonant rod, the top of the fixing member simultaneously presses against the metal resonant rod and the dielectric member.

6. The resonator according to claim 3, wherein the dielectric member comprises a first dielectric body and a second dielectric body connected axially, the outer diameter of the first dielectric body is larger than that of the second dielectric body, the first dielectric body is disposed in the first cavity, and the top surface of the first dielectric body is located on the same plane as the top surface of the first resonant part, the second dielectric body extends from the through hole, and the top of the fixing member is pressed against the first resonant part and the first dielectric body.

7. The resonator according to claim 6, wherein the dielectric member is formed with an inner cavity which is in communication with the second cavity.

8. The resonator according to claim 7, wherein the diameter of the through hole is smaller than the inner diameter of the connecting cavity and is greater than or equal to the inner diameter of the inner cavity of the dielectric member.

9. The resonator according to claim 1, further comprises a tuning screw and a nut connected to the tuning screw, the tuning screw is threaded connected to the cover plate and extends through the cover plate into the resonant cavity, and the nut is located outside the cover plate.

10. A filter, comprises a resonator according to claim 1, the housing of the resonator further comprises a mounting platform protruding from the bottom surface of the resonant cavity, the metal resonant rod is fixed on the mounting platform, the metal resonant rod and the mounting platform are connected by a connecting bolt.
